(19) United States
(12) Patent Application Publication
(10) Pub. No.: US 2010/0313692 A1
(43) Pub. Date: Dec. 16, 2010

(54) METHOD OF FABRICATING A DRIVE SHAFT FOR EARTH DRILLING MOTOR AND A DRIVE SHAFT

(76) Inventor: Kenneth H. WENZEL, Edmonton (CA)

Correspondence Address: DAVIS & BUJOLD, P.L.L.C., 112 PLEASANT STREET, CONCORD, NH, 03301, US

(21) Appl. No.: 12/723,062

(22) Filed: Mar. 12, 2010

(30) Foreign Application Priority Data
Jun. 10, 2009 (CA) 2668469

(51) Int. Cl. F16H 57/02; B23P 11/00

(52) U.S. Cl. 74/412 R; 29/428

(57) ABSTRACT

A method of fabricating a drive shaft for an earth drilling motor which includes providing a shaft having opposed ends. Gear profiles with teeth circumscribe each of the opposed ends. Teeth have an engaging face. End housings are provided for each of the opposed ends of the shaft and an interior bore is machined into each of the end housings. The interior bore receives one of the gear profiles at one of the opposed ends of the shaft, but won't accommodate rotation of the gear profiles. Radially spaced apertures are drilled through the end housings to provide drive key pockets with arcuate drive key engagement surfaces. Drive keys are inserted into the drive key pockets, with an arcuate surface of each drive key engaging the engagement surface of the end housings and the opposed surface of each drive key engaging the drive key engaging face of the teeth.

### FIELD

This relates to a method of fabricating a drive shaft used to couple an earth drilling motor used to drill hydrocarbon wells with a drill bit, and a drive shaft.

### BACKGROUND

U.S. Pat. Nos. 5,267,905 and 7,186,182 disclose drive shafts that are currently used to couple an earth drilling motor with a drill bit when drilling hydrocarbon wells. There is a need for method of fabricating drive shafts that is simpler and, consequently, less expensive.

### SUMMARY

According to one aspect there is provided a method of fabricating a drive shaft for an earth drilling motor which includes providing a shaft having a rotational axis, an exterior surface and opposed ends. Gear profiles are provided with teeth that project outwardly beyond the exterior surface and circumscribe each of the opposed ends of the shaft. Each of the teeth has a drive key engaging face. End housings are provided for each of the opposed ends of the shaft and an interior bore is machined into each of the end housings. The interior bore has a cross-sectional dimension that will receive one of the gear profiles at one of the opposed ends of the shaft, but will not accommodate rotation of the gear profiles. Radially spaced apertures are drilled through each of the end housings from an exterior surface into the interior bore to provide drive key pockets which each have an arcuate drive key engagement surface. The apertures are closed using a closing device, such as plugs inserted into the exterior surface of the end housings. End housings are positioned over opposed ends of the shaft, with an arcuate omni-directional engagement between the end housings and the opposed ends of the shaft. Drive keys are provided which have an arcuate surface and an opposed surface. The drive keys are inserted into the drive key pockets, with the arcuate surface of each drive key engaging the drive key engagement surface of the end housings and the opposed surface of each drive key engaging the drive key engaging face of the gear profile.

According to another aspect there is provided a drive shaft that has been fabricated in accordance with the method.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a drive shaft in an earth drilling motor.

FIG. 2 is a side elevation view, in section, of the drive shaft illustrated in FIG. 1.

FIG. 3 is a perspective view the drive shaft illustrated in FIG. 1.

FIG. 4 is an end elevation view of the drive shaft illustrated in FIG. 3.

FIG. 5 is a detailed side elevation view, in section, of the end housings of drive shaft illustrated in FIG. 1.

FIG. 6 is a perspective cutaway view of the drive shaft illustrated in FIG. 1.

FIG. 7 is end elevation view, in section, of one of the end housings.

FIG. 8 is an end elevation view, in section, of one of the end housings.

FIG. 9 is an end elevation view, in section, of the drive shaft engaged with one of the end housings.

FIG. 10 is a perspective view, in section, of the end housing.

FIG. 11 is a perspective view, in section of the end housing with the plugs.

FIG. 12 is an end view of an end housing with plug.

FIG. 13 is a perspective view of a drive key.

FIG. 14 is a top plan view of the drive key illustrated in FIG. 13.

FIG. 15 is a side elevation view of the drive key illustrated in FIG. 13.

FIG. 16 is an end elevation view of the drive key illustrated in FIG. 13.

FIG. 17 is an end elevation view, in section, of an alternative end housing,

FIG. 18 is a perspective view of an alternative drive shaft.

FIG. 19 is an end elevation view, in section, of an alternative drive shaft engaged with a corresponding end housing.

FIG. 20 is an end elevation view, in section, of an alternative end housing.

### DETAILED DESCRIPTION

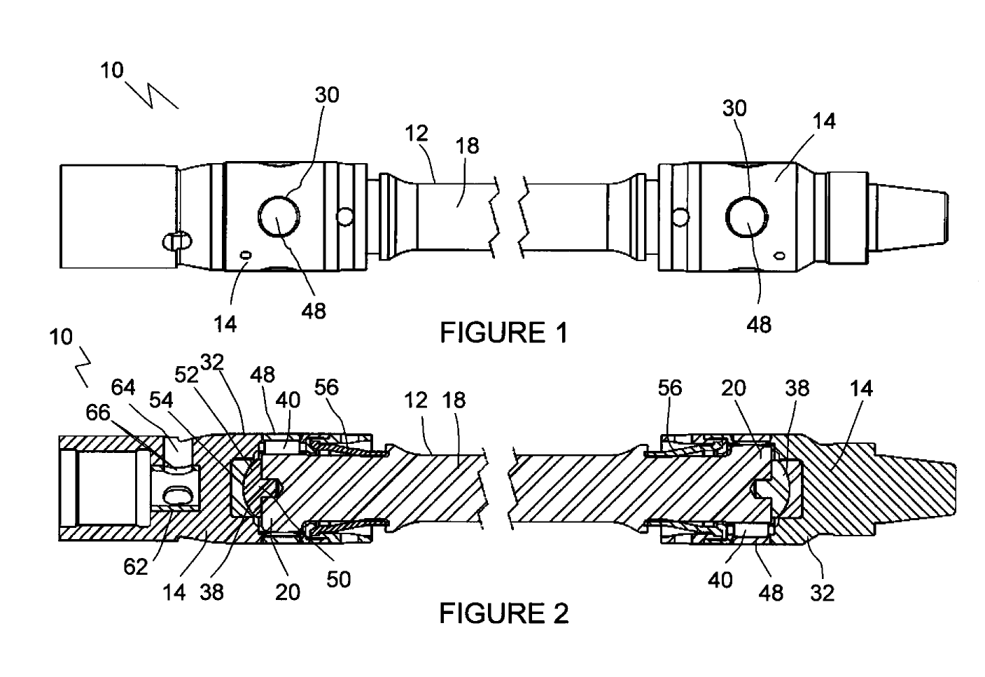

A drive shaft for an earth drilling motor generally identified by reference numeral 10, will now be described with reference to FIG. 1 through 16.

Structure and Relationship of Parts:

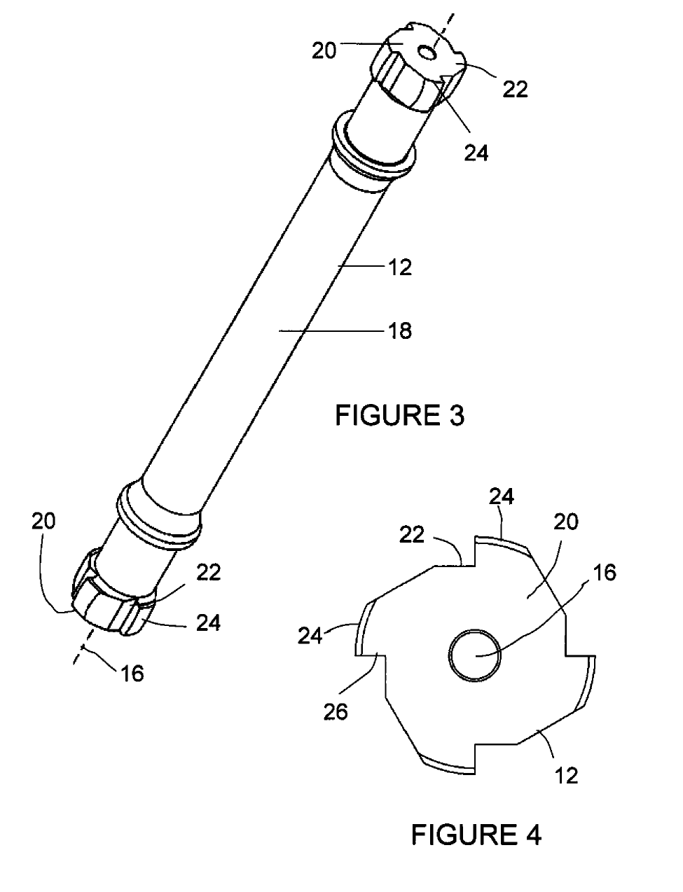

Referring to FIG. 1, there is illustrated a drive shaft generally referenced by the numeral 10. Referring to FIG. 2, drive shaft includes a shaft 12 and end housings 14. Referring to FIG. 3, shaft 12 has a rotational axis 16, an exterior surface 18 and opposed ends 20. Gear profiles 22 are positioned at each of opposed ends 20. Gear profiles 22 have teeth 24 that project outwardly beyond exterior surface 18 and circumscribe each of opposed ends 20 of shaft 12. Referring to FIG. 4, each of teeth 24 have a drive key engaging face 26.

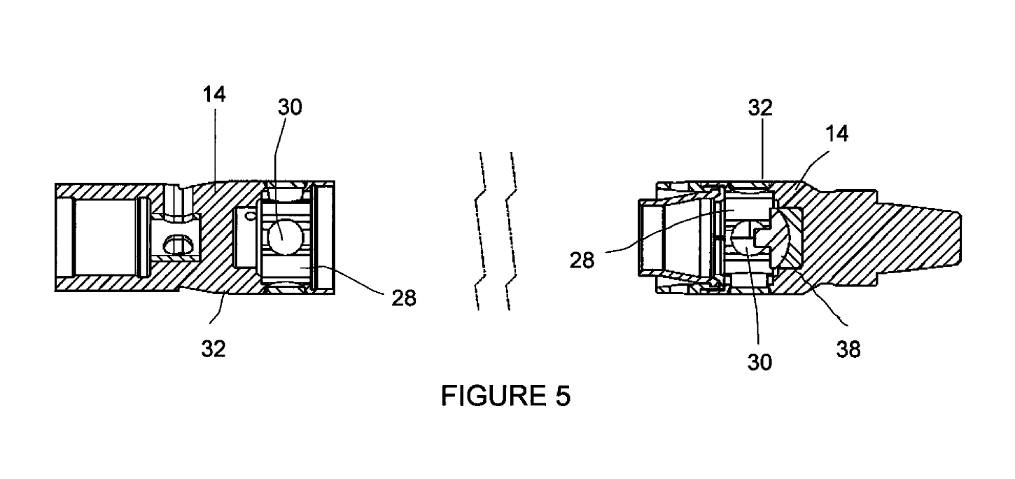

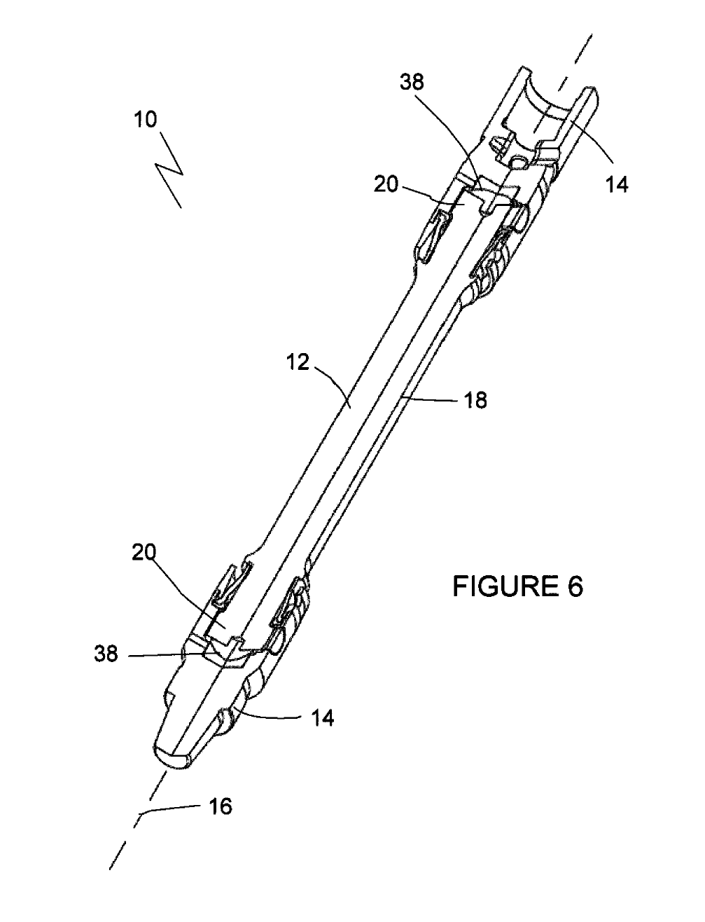

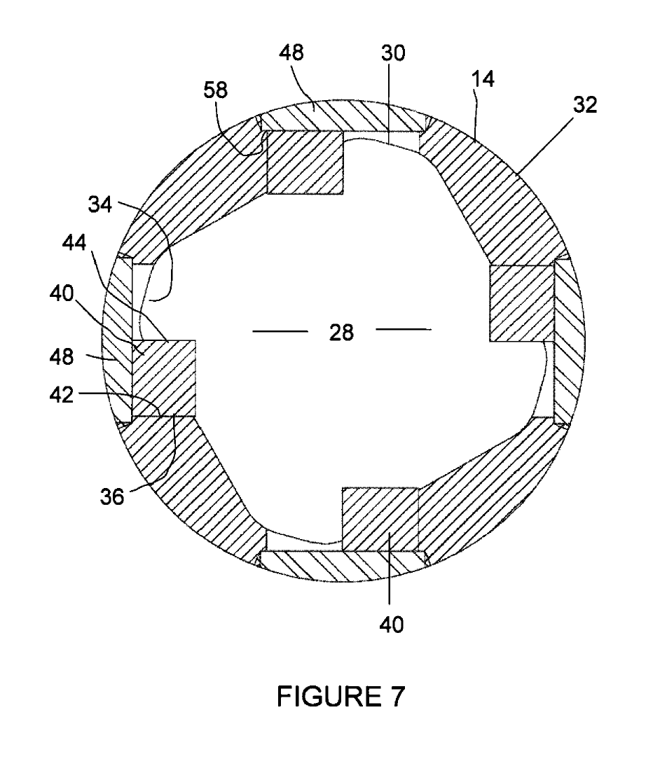

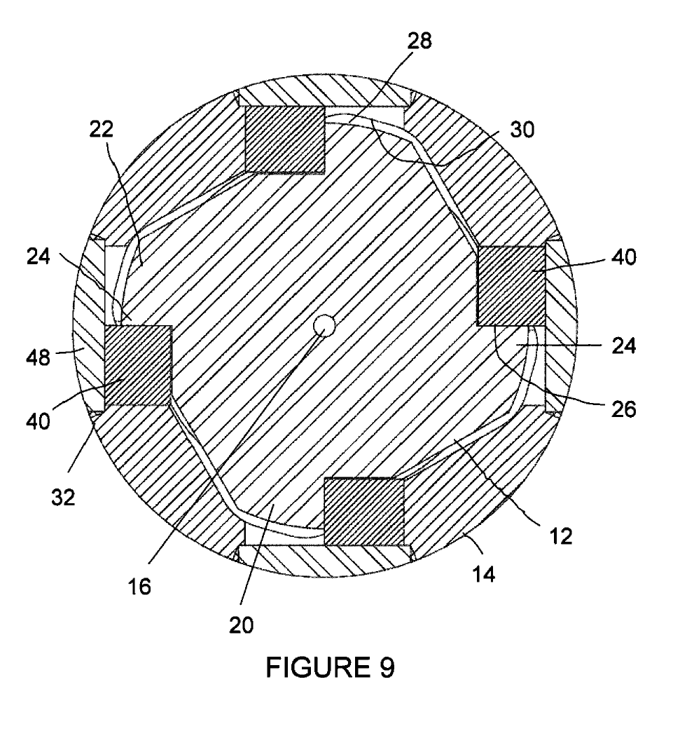

Referring to FIG. 6, end housings 14 are provided at each of opposed ends 20 of shaft 12. Referring to FIG. 5 and FIG. 7, an interior bore 28 is provided in each of end housings 14. Referring to FIG. 7, interior bore 28 has a cross-sectional dimension that will receive one of gear profiles 22 at one of opposed ends 20 of shaft 12 as illustrated in FIG. 9, but will not accommodate rotation of gear profiles 22.

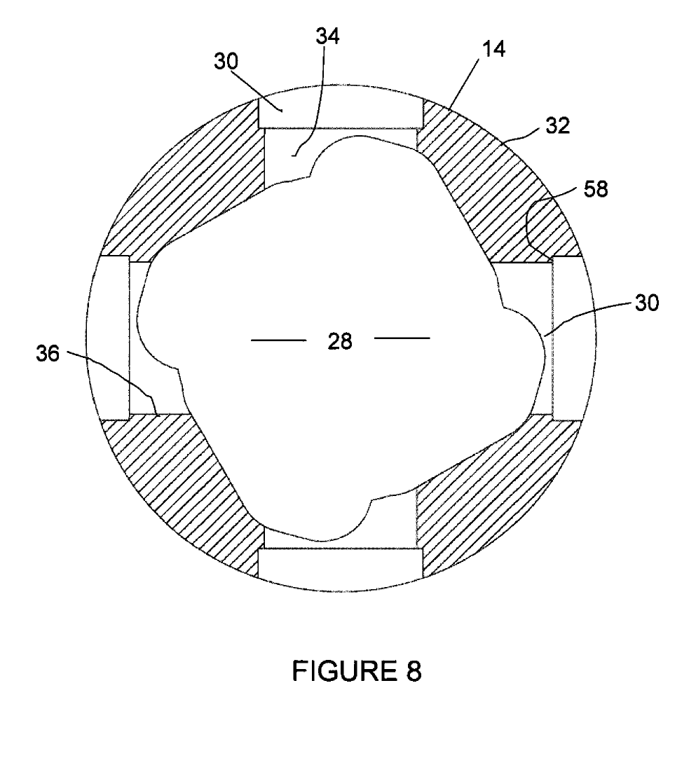

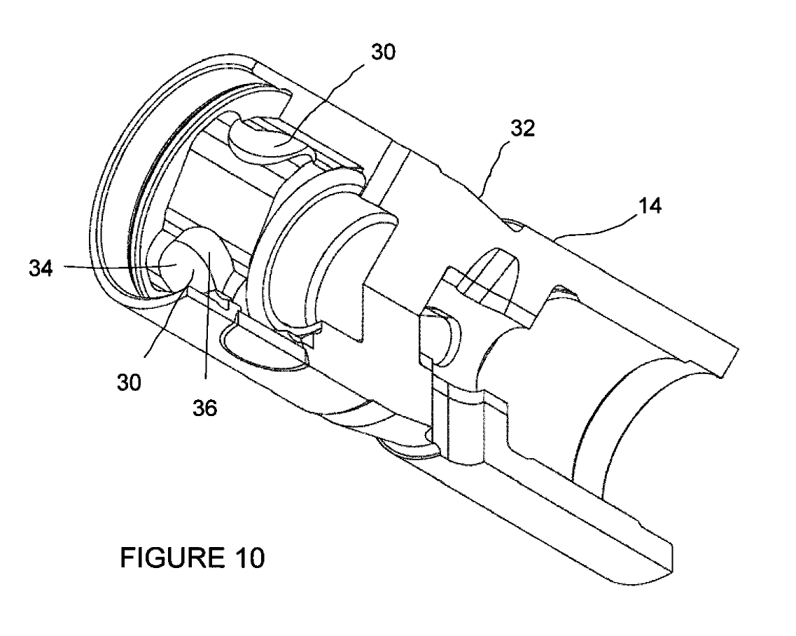

Referring to FIGS. 8 and 10, radially spaced apertures 30 are drilled through each of end housings 14 from an exterior surface 32 into interior bore 28 to provide drive key pockets 34 with an arcuate drive key engagement surface 36. Referring to FIG. 8, in the illustrated embodiment, apertures 30 are offset from each other by 90 degrees, and are preferably opposite each other to reduce the number of machining operations, as two apertures 30 can be machined without having to reposition housing 14. It will be understood, however, that there may be as few as 2 or 3 apertures and as many as 6 or more apertures, although it has been found that 4 apertures provides adequate results.

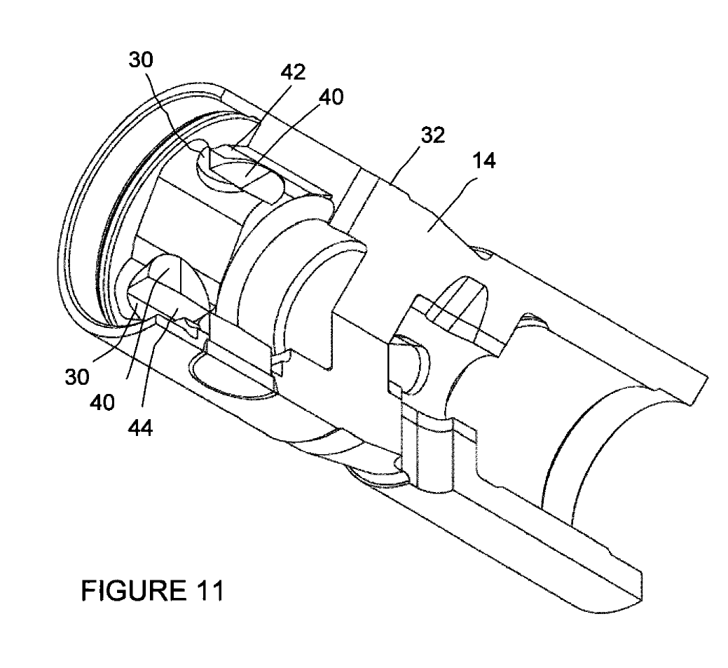

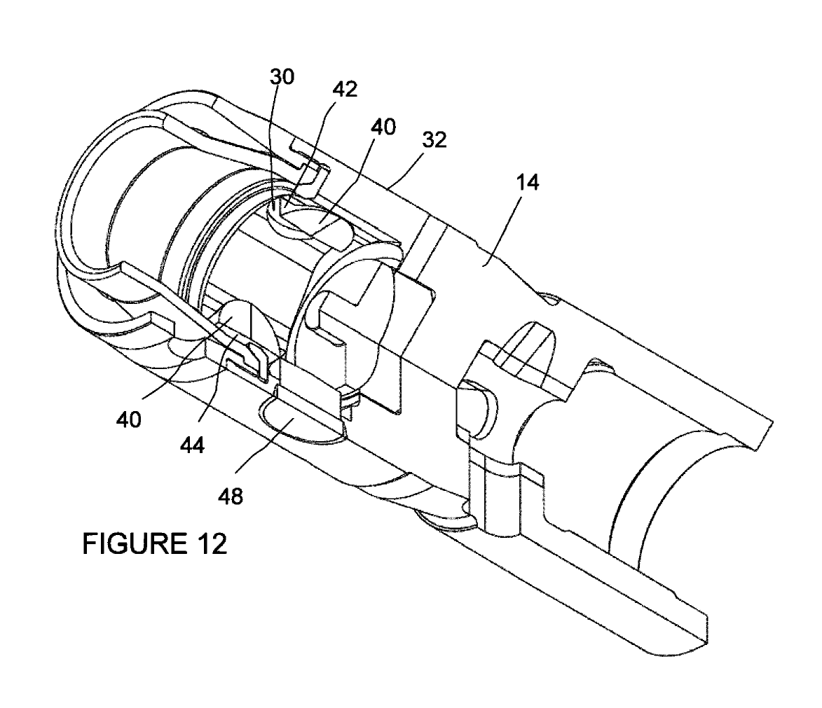

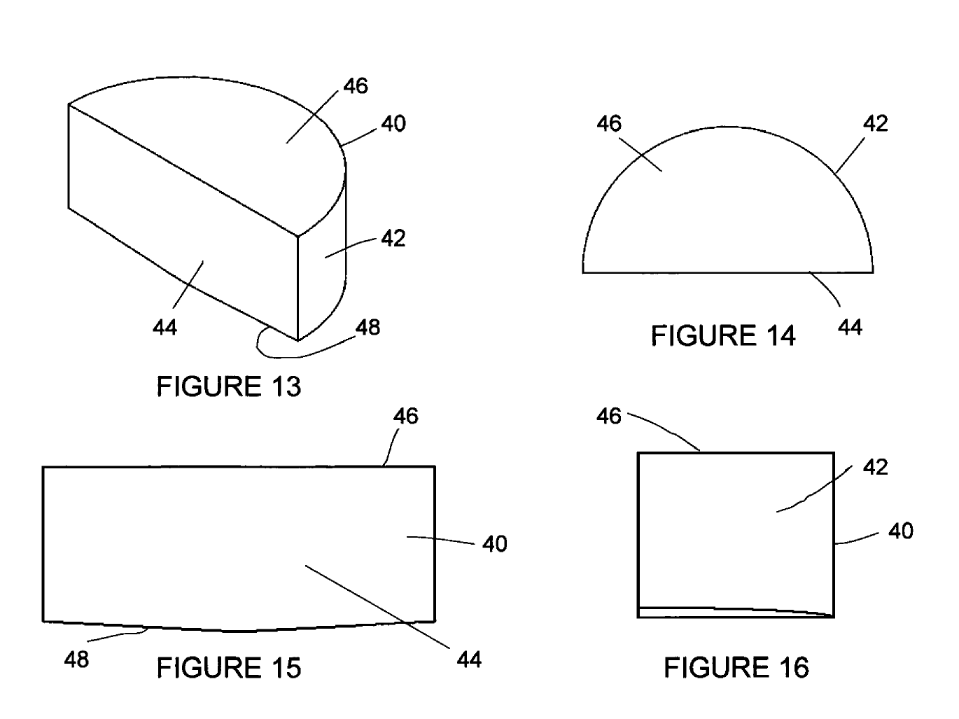

Referring to FIGS. 2 and 6, end housings 14 are positioned over opposed ends 20 of shaft 12 with an arcuate omni-directional engagement 38 between end housings 14 and opposed ends 20 of shaft 12 which facilitates omni-directional pivotal movement between shaft 10 and end housings 24. Referring to FIG. 13 through 16, drive keys 40 are provided which have an arcuate surface 42 and an opposed surface 44, preferably a flat opposed surface 44 as shown, as well as a top surface 46 and a bottom surface 49. Referring to FIGS. 11 and 12, drive keys 40 are positioned in drive key pockets 34 in each aperture 30 of end housings 14, with arcuate surface 42 of each drive key 40 engaging with drive key engagement surface 36 of end housings 14 and opposed surface 44 of each drive key 40 engaging with drive key engaging face 26 of gear profile 22 as illustrated in FIG. 9. Referring to FIG. 2, the use of drives keys 40 increases the surface contact area compared with previous U-joints utilizing balls, and thereby increases the torque load capacity of shaft 12 and end housings 14. Referring to FIG. 9, plugs 48 are provided in exterior surface 32 of end housings 14 as a closure device to close apertures 30. It will be recognized that other closure devices may be used to close apertures 30. While not necessary, an oversized opening is preferably machined into exterior surface 32 to receive plugs 48, which are then welded in place. The weld is then smoothed to recreate a solid exterior surface 32.

Referring to FIG. 2, there is shown a wear sleeve insert 62 located at a drilling fluid opening 64. Insert 62 have the same number of openings 66 in the same position as openings 64 in end housing 14. As drilling fluid flows toward the drill bit, it passes through openings 64 and 66. Because drilling fluid is generally quite abrasive, erosion may occur at openings 64. Wear sleeve insert 62 reduces this effect at the point where the drilling fluid is redirected to flow downward through the main mandrel to the drill bit (not shown). Wear sleeve insert 62 may be installed in various ways, such as by using an interference fit. End housing 14 is expanded by heating prior to inserting wear sleeve insert. As end housing 14 cools, wear sleeve insert 62 is secured in place.

Operation:

Referring to FIGS. 1 and 2, in operation drive shaft 10, torque that is transmitted to shaft 12 is then transmitted to end housing 14. Referring to FIG. 9, drive keys 40 are illustrated and can be considered as opposite pairs. At any given time each pair of keys 40 may be doing something slightly different in drive key pockets 34 in each aperture 30 of end housings 14. Referring to FIG. 7, forces directed from arcuate surface 42 to opposed surface 44 causes drive keys 40 to rock forward and back, while other keys permit some relative sliding of shaft 20.

Method of Manufacture:

Referring to FIGS. 1 and 2, there is illustrated a method of fabricating a drive shaft for an earth drilling motor generally referenced by numeral 10, which involves providing shaft 12 that has rotational axis 16, exterior surface 18 and opposed ends 20.

Referring to FIG. 3, gear profiles 22 are positioned on each of opposed ends 20 of shaft 12. Gear profiles 22 have teeth 24 that project outwardly beyond exterior surface 18 and circumscribe each of opposed ends 10 of shaft 12. Referring to FIG. 4, as described previously, each of teeth 24 have drive key engaging face 26. Referring to FIG. 6, end housings 14 are provided for each of opposed ends 20 of shaft 12. Interior bore 28 is machined into each of end housings 20. As illustrated in FIG. 7, interior bore 28 has a cross-sectional dimension that will receive one of gear profiles 22 at one of opposed ends 20 of shaft 20, but will not accommodate rotation of gear profiles 22.

Referring to FIG. 8, radially spaced apertures 30 are drilled through each of end housings 14 from exterior surface 32 into interior bore 28 to provide drive key pockets 34 with arcuate drive key engagement surface 36 as illustrated in FIG. 10.

Referring to FIGS. 2 and 6, end housings 14 are positioned over opposed ends 20 of shaft 12, with arcuate omni-directional engagement 38 between end housings 20 and opposed ends 20 of shaft 12. Referring to FIG. 2, in the illustrated embodiment, omni-directional engagement 38 includes a first portion 50 having an arcuate face 52, and a second concave seat portion 54 that is shaped to receive arcuate shaped face 52 of first portion 50. It will be appreciated that arcuate omni-directional engagement 38 may have other configurations than as described above. A circumferential boot 56 is positioned between each opposed ends 20 of shaft 12 and overlies end housings 14.

Referring to FIGS. 9 and 12 plugs 48 are inserted through exterior surface 32 of end housings 14 to close apertures 30. Referring to FIG. 8, a circumferential lip 58 is provided within aperture 30. Referring to FIG. 7, circumferential lip 58, formed by machining an oversized hole over aperture 30, prevents plug 48 from being inserted too far into apertures 30.

Drive keys 40 having arcuate surface and opposed surface 44 as illustrated in FIG. 13 through 16 are inserted into drive key pockets 34 as shown in FIGS. 7 and 11. Referring to FIG. 9, arcuate surface 42 of each drive key 40 engages drive key engagement surface 36 of end housings 14 and opposed surface 44 of each drive key 40 engages drive key engaging face 26 of gear profile 22.

Compared to fabrication techniques currently employed, the present method provides a significant saving in labour time and, consequently, in cost. The formation of the gear profiles 22 on shaft 12 is relatively simple. The drilling of apertures 30 to form drive key pockets 34 is, similarly, relatively simple. This is to be contrasted with the effort formerly required to form internal keyways within the end housings using cantilever supported cutting tools as has been previously done.

Advantages:

In the prior art, the arcuate surfaces were positioned on the drive shaft. The present fabrication method allows the arcuate surfaces to be positioned in the end housings instead. This may be done more quickly, as two arcuate surfaces may be formed in a single operation by a machining tool when apertures are opposite to another aperture.

In the prior art, the flat surface in the interior bore was made using a slotting tool or by using a round bit. The round bit left a radiused portion in the corner, such that the surface was not entirely flat, which prevented the key from being out as far as possible, which maximizes the drive force that can be applied. Furthermore, there is a practical limit as to the size of the radiused portion, since smaller diameter bits are less rigid, and more likely to deviate from a straight cut. Another method of forming a flat surface is to use a slotting tool, however, this requires an undercut at the back of the housing bore, which weakens the end housing. The present method of fabrication allows flat surfaces to be formed relatively quickly and easily. Furthermore, as plugs are welded as caps to the apertures in the preferred embodiment, the strength of the end housings are not significantly affected.

Variation:

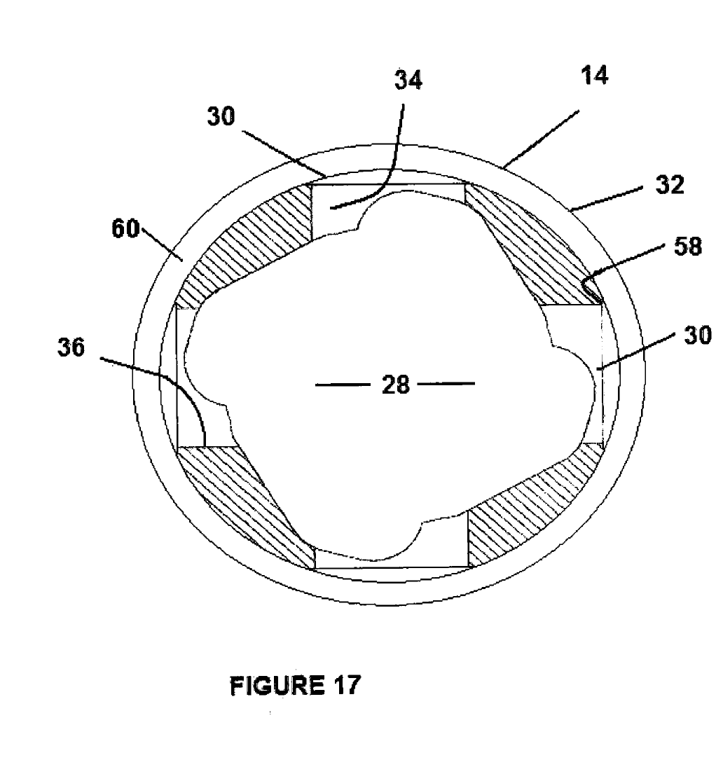

The embodiment above describes a situation where apertures 30 are covered by inserting plugs 48. This has the advantage of being able to provide a flat surface against which drive keys 40 are positioned. However, other approaches may be used to cover apertures 30. For example, referring to FIG. 17, a sleeve 60 or band may be installed around housing 14 where apertures 30 are located. In order to avoid having sleeve 60 extend outward past the outer surface of end housing 14, it would then be necessary to machine housing 14 smaller. The sleeve 60 would be sealed in place, such as by welding. This is not a preferred method, as it tends to weaken housing 14, as well as making it more difficult to provide a flat surface as with plugs 48. To compensate for this, drive keys could be machined with a radius to match the sleeve's radiused surface, however this results in increased manufacturing costs for drive keys 40. This alternative example is used to demonstrate that other means of closing apertures 30 from the outside after machining is complete may be used.

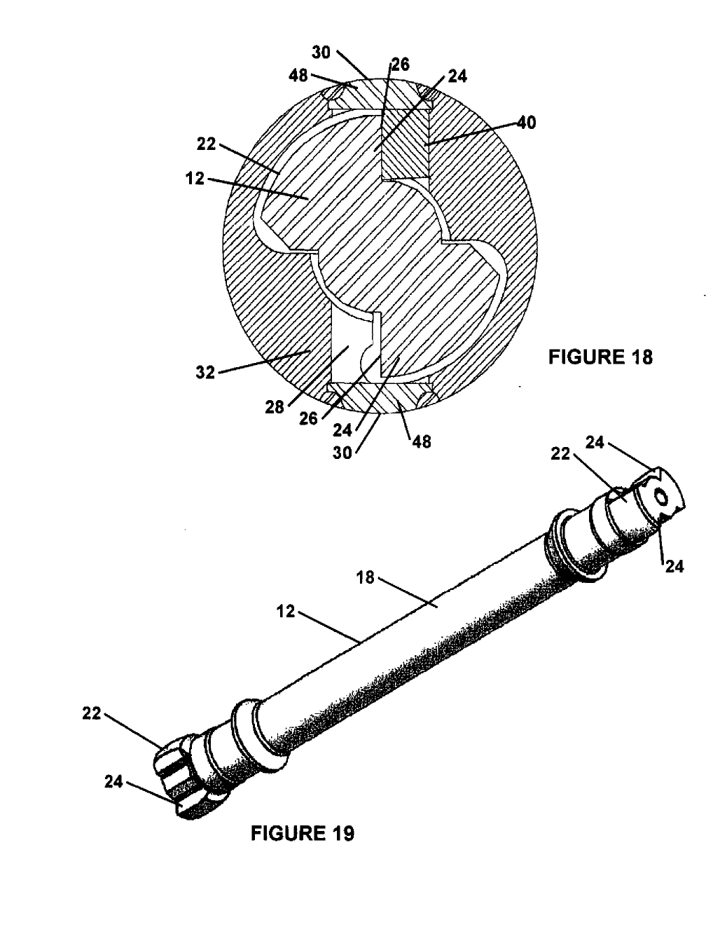

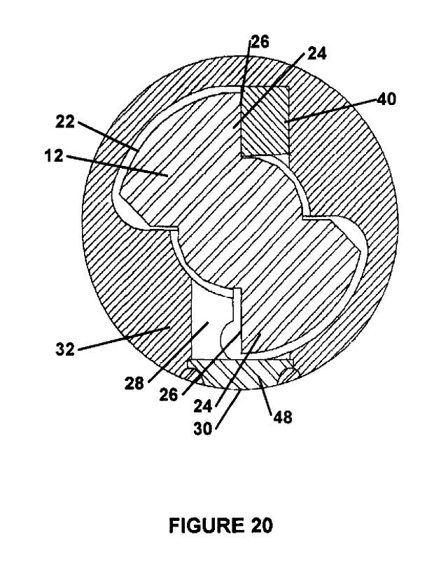

While four drive keys 40 have been shown, it will be understood that there may be more or less than this. For example, referring to FIG. 19, two keys 40 may be used. This design has certain advantages. As there are only two points of contact, there is a more consistent application of force. When using four keys 40, it is important to replace keys 40 into the proper pockets 34, as each may have a different amount of wear, which could result in some keys 40 not bearing their share of the force. With only two keys 40, this is not a concern. In addition, if the embodiment depicted in, for example, FIG. 9, is subjected to a backlash, drive shaft 12 will apply a radial force to key 40 that may result in plugs 48 being pushed out of aperture 30. Referring to FIGS. 18 and 19, drive shaft 12 has been designed with a constant diameter behind key 40, such that any backlash will not apply a radial force to plugs 48. Another advantage is that, as fewer apertures 30 are machined, housing 14 is weakened less.

Another approach to weaken housing 14 less is to only machine one aperture 30 for each pocket 34. In the previous discussions, aperture 30 either extends through the entire housing 14, or an aperture 30 is machined for each aperture 30. Alternatively, referring to FIG. 20, it is possible to machine one aperture 30 for every two pockets 34. The bit is inserted from one side, creates a pocket 34 on that side, and then only extends far enough to create a pocket in the other side as well, rather than passing all the way through.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A method of fabricating a drive shaft for an earth drilling motor, comprising:
providing a shaft having a rotational axis, an exterior surface and opposed ends;
positioning gear profiles having teeth that project outwardly beyond the exterior surface and circumscribe each of the opposed ends of the shaft, each of the teeth having a drive key engaging face;
providing end housings for each of the opposed ends of the shaft and machining an interior bore in each of the end housings, the interior bore having a cross-sectional dimension that will receive one of the gear profiles at one of the opposed ends of the shaft, but will not accommodate rotation of the gear profiles;
drilling at least one aperture from an exterior surface into the interior bore of each end housing to provide drive key pockets with an arcuate drive key engagement surface;
closing the at least one aperture at the exterior surface of the end housings with a closure device;
positioning the end housings over opposed ends of the shaft, with an arcuate omni-directional engagement between the end housings and the opposed ends of the shaft;
providing drive keys having an arcuate surface and an opposed surface; and
inserting the drive keys into the drive key pockets, with the arcuate surface of each drive key engaging the drive key engagement surface of the end housings and the opposed surface of each drive key engaging the drive key engaging face of the gear profile.

2. The method of claim 1, comprising more than one radially spaced aperture.

3. The method of claim 2, wherein the radially spaced apertures are offset by 90 degrees.

4. The method of claim 1, wherein each radially spaced aperture forms two drive key pockets in the interior bore on opposed sides of the end housing.

5. The method of claim 1, wherein the closure device comprises a plug for each aperture.

6. The method of claim 5, further comprising machining an oversized opening in the exterior surface of the end housing corresponding to each aperture for receiving each plug to a specified depth.

7. The method of claim 5, wherein the plugs are welded into each aperture.

8. The method of claim 1, wherein the closure device comprises a sleeve.

9. A method of fabricating a drive shaft for an earth drilling motor, comprising:
providing a shaft having a rotational axis, an exterior surface and opposed ends
machining gear profiles having teeth that project outwardly beyond the exterior surface and circumscribe each of the opposed ends of the shaft, each of the teeth having a drive key engaging face;
providing end housings for each of the opposed ends of the shaft and machining an interior bore in each of the end housings, the interior bore having a cross-sectional dimension that will receive one of the gear profiles at one of the opposed ends of the shaft, but will not accommodate rotation of the gear profiles;
drilling at least one aperture through each of the end housings from an exterior surface into the interior bore of each end housing to provide drive key pockets on opposed sides of the end housing with an arcuate drive key engagement surface;
inserting plugs into the exterior surface of the end housings to close the apertures;
positioning the end housings over opposed ends of the shaft, with an arcuate omni-directional engagement between the end housings and the opposed ends of the shaft;
inserting the drive keys into the drive key pockets, with the arcuate surface of each drive key engaging the drive key engagement surface of the end housings and the opposed surface of each drive key engaging the drive key engaging face of the gear profile.

10. A drive shaft for an earth drilling motor, comprising:
a shaft having a rotational axis, an exterior surface and opposed ends;
gear profiles having teeth that project outwardly beyond the exterior surface and circumscribing each of the opposed ends of the shaft, each of the teeth having a drive key engaging face;
end housings having an interior bore, the interior bore having a cross-sectional dimension that will receive one of the gear profiles at one of the opposed ends of the shaft, but will not accommodate rotation of the gear profiles;
at least one aperture extending from an exterior surface into the interior bore of each end housing to form radially spaced drive key pockets with an arcuate drive key engagement surface in the interior bore of the end housings;
a closure device for closing the radially spaced apertures at the exterior surface of the end housings;
the end housings positioned over opposed ends of the shaft, with an arcuate omni-directional engagement between the end housings and the opposed ends of the shaft;
drive keys having an arcuate surface and an opposed surface with the drive keys being positioned in the drive key pockets, with the arcuate surface of each drive key engaging the drive key engagement surface of the end housings and the opposed surface of each drive key engaging the drive key engaging face of the gear profile

11. The drive shaft of claim 10, wherein the closure device comprises plugs welded into each of the radially spaced apertures.

12. The drive shaft of claim 10, wherein the closure device comprises a sleeve that covers the radially spaced apertures.
